(19) United States
(12) Patent Application Publication
(10) Pub. No.: US 2025/0353071 A1
(43) Pub. Date: Nov. 20, 2025

(54) Riveting device having a compact design

(71) Applicant: SFS Group Germany GmbH, Oberursel (DE)

(72) Inventor: Robert KÖLM, Neu-Anspach (DE)

(73) Assignee: SFS Group Germany GmbH, Oberursel (DE)

(21) Appl. No.: 18/871,673

(22) PCT Filed: Jun. 29, 2023
(86) PCT No.: PCT/DE2023/100496

§ 371 Date: Dec. 4, 2024

(30) Foreign Application Priority Data
Jun. 30, 2022 (DE) 10 2022 116 419.5

(51) Int. Cl. B21J 15/10; B21J 15/04; B21J 15/26; B21J 15/32; B25B 27/00; B25F 5/00; B25F 5/02

(52) U.S. Cl. CPC B21J 15/105; B21J 15/043; B21J 15/26; B21J 15/326; B25B 27/0014; B25F 5/001; B25F 5/02

(57) ABSTRACT

The present disclosure comprises a riveting device (1) having a device housing (5), a riveting tool (10) and a drive device (30) in the device housing (5) for actuating the riveting tool (10). The riveting tool (10) has a mouthpiece (11) and a mandrel holder (12) that can be moved relative to the mouthpiece (11) along an operative axis (w). The drive device (30) has a threaded spindle (33) which has a feed thread (33.3), is operatively connected to the mandrel holder (12) and is configured to move along the operative axis (W). The threaded spindle (33) is formed as a hollow spindle having a through hole (40) extending in the direction of its longitudinal extension, and the threaded spindle (33) is assigned a torque arm (41) which secures the threaded spindle (33) against rotation relative to the device housing (5). The torque arm (41) is fixed on the threaded spindle (33) via the through hole (40) to improve the compactness.

### CROSS-REFERENCE TO RELATED APPLICATION

This application is a national stage application, filed under 35 U.S.C. § 371, of International Patent Application PCT/DE2023/100496 filed on Jun. 29, 2023, which claims the benefit of German Patent Application DE 10 2022 116 419.5, filed on Jun. 30, 2022.

### TECHNICAL FIELD

The present disclosure refers to a riveting device and in particular a blind rivet setting tool, a blind rivet nut setting tool and a blind rivet screw setting tool.

### BACKGROUND

Riveting devices are typically used to produce a rivet connection between two or more materials, such as for example metal sheets, at a connection point at which the materials are placed on each other. To form the rivet connection, a plastically deformable, often cylindrical connecting element is used which is generally referred to as a rivet. The rivet usually has a rivet head prefabricated on one end. To produce the rivet connection, the rivet is introduced into a connection hole at the connection point up to the rivet head and then the other end of the rivet is plastically deformed to form a closing head.

Riveting devices can also be used to provide components with a thin wall with a thread. Rivet nuts or rivet screws are used for this, with which a rivet is combined with an element comprising a thread. The rivet nuts or rivet screws are introduced into a prefabricated rivet hole of the component and subsequently a region of the rivet is plastically deformed to form a closing head.

Commonly used riveting devices usually comprise a riveting tool which is set up to cause a plastic deformation forming the closing head. The riveting devices have a drive device accommodated in a device housing for actuating the riveting tool. Often the drive device is electromechanical and comprises, for example, an electric motor and a spindle gear formed as a ball screw drive having a threaded spindle and a spindle nut. Typically, the spindle nut is driven by the electric motor and the threaded spindle is secured by torque arms against rotation, so that the threaded spindle shifts axially and in the process acts on the riveting tool when the spindle nut rotates.

Such a riveting device is also described in EP 0 527 414 A1. The riveting device is formed and set up for blind riveting; by exerting a pulling movement, a rivet mandrel is pulled out from the rivet body of a blind rivet, compressing the rivet body to create a closing head, until it results in tear-off of the rivet mandrel. The torn-off rivet mandrel piece can be disposed of in a collection container via a continuous bore in the threaded spindle and an adjoining tubular element.

In this riveting device, the torque arms are fixed on the outer circumference of the threaded spindle, and specifically on a back end of the threaded spindle facing towards the collection container. The torque arms take up a radial installation space in the area of the back end of the threaded spindle, which is larger in the vertical direction of the riveting tool towards the electric motor than the diameter of the threaded spindle in the area of its feed thread.

In this riveting device, the tubular element is also fixed axially immovably on the device housing. For this purpose, an intermediate sleeve is inserted into a through-opening in the device housing so that it cannot move axially, to which intermediate sleeve the tubular element is attached in the centre on one side and a holder for the collection container is screwed on on the other side. To perform this fixing function, the intermediate sleeve protrudes from the inner side of the device housing with a longitudinal section and thus occupies axial installation space in the interior of the device housing.

### SUMMARY

In the course of continuous further development, there may be a need to improve the compactness of a riveting device. This is based on the expectation that improved compactness will make it easier to reach hard-to-reach riveting points in order to set a rivet there. It is also expected that improved compactness will make the riveting device lighter and/or easier to handle.

An embodiment of a basic riveting device comprises a device housing, a riveting tool and a drive device, preferably in the device housing, for actuating the riveting tool. For example, the riveting device, in particular the riveting tool, is suitable for blind riveting, during which, by means of a rivet mandrel, the riveting process is carried out from one side of the material to be provided with a blind rivet. A blind rivet nut or a blind rivet screw can also be used instead of a blind rivet.

Preferably, the riveting tool has a mouthpiece and a mandrel holder, that can be moved relative to the mouthpiece along or in the direction of an operative axis. For example, the mandrel holder comprises a chuck housing that can be moved relative to the mouthpiece along or in the direction of the operative axis and at least one clamping element, in particular clamping jaw, that can be moved in the chuck housing along a clamping path.

Preferably, the drive device has a threaded spindle, preferably comprising a feed thread, which is operatively connected to the mandrel holder and in particular is set up to move along the operative axis. In particular, the threaded spindle is formed as a hollow spindle with a through hole extending in the direction of its longitudinal extension, for example to provide a mandrel removal path. In particular, the threaded spindle is assigned a torque arm, which secures the threaded spindle against rotation relative to the device housing.

An improvement in compactness is offered by an embodiment of the riveting device in which the torque arm is fixed on the threaded spindle via the through hole. To fix the torque arm, the through hole of the threaded spindle is thus used. In this manner, the fixing has a lower radial installation space requirement in comparison to a fixing on the outer circumference of the threaded spindle, for example.

The improved riveting device can be designed so that the torque arm is fixed by screwing into the through hole on the threaded spindle. This makes it easy to fix the torque arm to the threaded spindle in a stable manner.

Further progress is achieved additionally or alternatively by an embodiment in which the torque arm is fixed to the threaded spindle by screwing via a fixing thread, wherein the fixing thread and the feed thread of the threaded spindle run in opposite directions to each other. Therefore, releasing the screw connection between the torque arm and the threaded spindle is counteracted by actuating the riveting device or during operation of the drive device. Instead, this method favours a self-tightening of the torque arm during a pulling process by the threaded spindle or a movement of the threaded spindle. This is easy to install and saves costs.

For example, the fixing thread is formed in the through hole of the threaded spindle. For example, the fixing thread may be an internal thread. For example, the torque arm is screwed in the through hole by engaging into the fixing thread.

In one embodiment, the torque arm has a base body which protrudes axially from the threaded spindle. In this case, the improved riveting device can be designed so that the base body prevents rotation with respect to a counter bearing, for example directly or indirectly via at least one intermediate element. Therefore, a technically simple realisation of the torque arm is favoured, the fixing of which on the threaded spindle takes place via the through hole. For example, the counter bearing is fixed to the device housing and/or is secured against rotation with respect to the device housing.

The improved riveting device can also be designed so that the base body has a bore extending transversely, in particular orthogonally, to the spindle axis of the threaded spindle, in which a magnetically acting magnet element for a Hall sensor device, such as a permanent magnet for example, is received. As a result, the base body has a multi-part function. Therefore, an improved functional integration is achieved. A simple fixing of the magnet element is favoured for example when the intermediate element is an iron element, i.e. is ferrous, and the bore is arranged near to the intermediate element. As a result, the magnet element can be held in the bore due to the acting magnetic force.

The improved riveting device can also be designed so that originating from the spindle axis, the base body has a radial extension in at least one spatial direction in relation to the spindle axis, which radial extension is smaller than or equal to the radial extension of the threaded spindle in the region of the base body. Such radial compactness of the base body is enabled due to fixing the torque arm via the through hole of the threaded spindle.

In one embodiment, the threaded spindle is engaged with a spindle nut of a spindle gear and in particular the drive device has an electric motor, and a reduction stage interposed between the electric motor and the spindle gear, preferably having an intermediate shaft. In particular, the reduction stage and/or the intermediate shaft and/or the output shaft of the electric motor is arranged axially parallel to the spindle axis of the threaded spindle. In particular, the reduction stage is arranged between the spindle nut and a wall section of the device housing in the axial direction.

The improved riveting device can be designed in this embodiment so that the reduction stage has a radial extension, originating from the shaft axis, which is smaller than the distance between the shaft axis of the intermediate shaft and the facing outer side of the base body and/or the facing outer side of the threaded spindle. Therefore, reducing axial installation space is favoured, since a consecutive axial arrangement of the space to be kept free for the actually utilised stroke of the threaded spindle, on the one hand, and the reduction stage, on the other, can be avoided. In this respect, this measure also helps to improve the compactness of the riveting device.

Further progress is achieved additionally or alternatively by an embodiment in which the intermediate shaft is mounted radially integral with the housing in relation to the housing via a radial bearing and the radial bearing is on the side of the reduction stage facing away from the wall section of the device housing. Therefore, a radial bearing on the side of the reduction stage facing towards the wall section can be avoided and the intermediate shaft can be made shorter, thereby reducing axial installation space. A shortened intermediate shaft also results in a weight advantage. In particular, the measure that a gear element of the reduction stage is arranged on the intermediate shaft in the region of a free end of the intermediate shaft facing the wall section or is arranged on an end of the intermediate shaft facing the wall section also has this effect.

In one further embodiment, the riveting device comprises a spring element, which acts with a force inside the mandrel holder. For example, the spring element is set up to apply a force to the at least one clamping element, forcing it into the chuck housing. In particular, the spring element is arranged in the through hole of the threaded spindle.

In this embodiment, the improved riveting device can be designed so that a section or extended section of the torque arm present in the through hole is used as a counter holder for the spring element. The torque arm is thus used as a component to prevent rotation of the threaded spindle and furthermore performs a counter-holding function for the spring element. This multiple function of the radial arm achieves an improved functional integrity.

In a further embodiment, the riveting device comprises a tubular element and a collection container, for example for mandrel remnants or torn off rivet mandrel pieces. In particular, a connecting channel, especially a mandrel channel, is formed from the through hole of the threaded spindle to the collection container via the tubular element. In particular, the tubular element is fixed on a wall section of the device housing, for example the above-described wall section. In particular, the wall section extends transversely, for example orthogonally to the tube axis of the tubular element. In particular, the wall section has an inner side facing towards the threaded spindle and an opposite outer side.

Further progress in the compactness is achieved additionally or alternatively by an embodiment in which the tubular element has a fixing structure, which essentially ends flush with the inner side and/or the outer side of the wall section or is lower than the inner side and/or the outer side of the wall section. Therefore, this can save on additional installation space for the fixing structure in the axial direction in relation to the operative axis or the spindle axis.

Further progress in compactness is achieved additionally or alternatively by an embodiment in which the tubular element has a fixing structure with two flange portions which each extend along a different circumferential section around the outer circumference of the tubular element and have a flange surface which cooperates with a mating surface of the wall section, wherein the flange surfaces point in opposite directions to one another and/or face one another axially and one of the mating surfaces is formed on the inner side and the other mating surface is formed on the outer side of the wall section. Therefore, a compact design of the fixing of the tubular element on the device housing is possible in the axial direction in relation to the operative axis or the spindle axis. Installation of the tubular element on the device housing is also facilitated, since no additional fixing elements are required. This is because the two flange surfaces of the tubular element alone enable the tubular element to be secured in its axial position relative to the device housing by means of positive locking.

The further improved riveting device can be designed so that the device housing is multi-part and has at least two housing parts lying next to each other in a parting plane, each of which is assigned one of the mating surfaces of the wall section. Therefore, simple mounting of the tubular element on the device housing is favoured. The fixing of the tubular element can be realised simply by joining together the housing parts.

Further progress in the compactness is achieved additionally or alternatively in an embodiment in which the tubular element engages into the through hole of the threaded spindle, in particular directly and/or immediately. As a result, the installation space to be provided in the axial direction in relation to the operative axis or the spindle axis essentially needs to be designed for the stroke that can be performed by the threaded spindle. In particular, the tubular element engages telescopically into the through hole of the threaded spindle. In the present disclosure, this is to be understood to mean that when the threaded spindle performs a stroke movement, the tubular element comes out more or less out of the through hole, but preferably remains engaged in the through hole.

In a further embodiment, the riveting device is formed as a hand riveting device and comprises a handle part which, for example, has a longitudinal extension transverse to the operative axis. For example, the handle part is formed on the device housing, in particular moulded thereon. The riveting device can be held in the hand or manually guided by the handle part. In particular, the handle part allows the riveting device to be positioned manually at a point to be riveted.

According to one aspect, a blind rivet setting tool is proposed. The blind rivet setting tool comprises the above-described riveting device and has a rivet mandrel received in its mandrel holder of a blind rivet to be set.

According to a further aspect, a blind rivet nut setting tool is proposed. The blind rivet nut setting tool comprises the above-described riveting device and has a threaded rivet mandrel received in its mandrel holder for a blind rivet nut to be set.

According to a further aspect, a blind rivet screw setting tool is proposed. The blind rivet screw setting tool comprises the above-described riveting device and has a threaded rivet mandrel received in its mandrel holder of a blind rivet screw to be set.

Further characteristics and features result from the following description of several exemplary embodiments with reference to the drawings.

### BRIEF DESCRIPTION OF THE DRAWINGS

FIG. 1 shows an exemplary embodiment of a riveting device having a riveting tool and a drive device for actuating the riveting tool in a schematic sectional representation,

FIG. 2 shows the exemplary riveting device in an enlarged section of FIG. 1 in the region of the drive device and a torque arm,

FIG. 3 shows the exemplary riveting device in an enlarged section in the region of the torque arm as a sectional representation along the section line A-A of FIG. 2,

FIG. 4 shows the torque arm of the exemplary riveting device of FIG. 1 in a schematic representation as a perspective view,

FIG. 5 shows the exemplary riveting device in an enlarged section of FIG. 1 in the region of a tubular element for the mandrel removal,

FIG. 6 shows the tubular element of the exemplary riveting device of FIG. 1 in an enlarged region of a fixing structure as a perspective representation,

FIGS. 7 and 8 show in each case a housing part of a device housing for the exemplary riveting device of FIG. 1 in an enlarged region of a receptacle for the tubular element of FIG. 6,

FIG. 9 shows a possible embodiment of a blind rivet setting tool having the exemplary riveting device of FIG. 1 in a schematic partial representation,

FIG. 10 shows a possible embodiment of a blind rivet nut setting tool having the exemplary riveting device of FIG. 1 in a schematic partial representation, and

FIG. 11 shows a possible embodiment of a blind rivet screw setting tool having the exemplary riveting device of FIG. 1 in a schematic partial representation.

### DETAILED DESCRIPTION

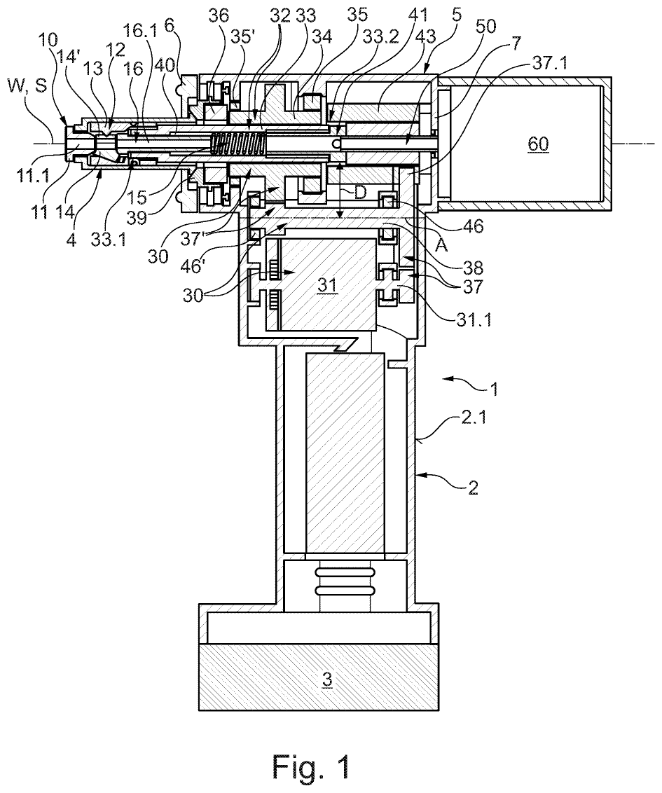

FIG. 1 shows the construction of an exemplary embodiment of a riveting device 1 which is also referred to as a setting device by experts. The exemplary riveting device 1 is suitable for applying rivets according to the blind riveting method, and in this regard is designed for using blind rivets.

The exemplary riveting device 1 comprises a riveting tool 10 and a drive device 30 for actuating the riveting tool 10. Preferably, the riveting tool 10 is received in a tool housing 4. Preferably, the drive device 30 is received in a device housing 5. Preferably, the tool housing 4 is a metal housing. Preferably, the device housing 5 is a plastic housing.

The exemplary riveting device 1 can be a hand riveting device. The hand riveting device 1 has a gripping surface 2.1 which can be formed at least partially on the device housing 5. For example, the hand riveting device 1 has a handle part 2 which is at least partially formed by the device housing 5. The riveting device 1 can be held in the hand by the gripping surface 2.1 or the handle part 2 when it is used for setting a rivet, in particular a blind rivet, on a workpiece. The riveting process as such then takes place by actuating the riveting tool 10 via the drive device 30.

Preferably, the drive device 30 is an electromechanical drive device. The electromechanical drive device 30 comprises for example an electric motor 31 having a rotatable output shaft 31.1 and preferably a spindle gear 32, which can be driven by the electric motor 31. Preferably, the spindle gear 32 is set up to convert a rotational drive movement, coming from the output shaft 31.1 into a translational drive movement which acts along an operative axis W to actuate the riveting tool 10. The spindle gear 32 can be a ball screw drive.

A preferably replaceable electrical energy storage device, such as an accumulator 3, can be provided for the electrical energy supply of the drive device 30, which energy storage device is arranged, for example, in the region of an end of the handle part 2 facing away from the riveting tool 10. Therefore, the riveting device 1 can be a cordless tool.

The riveting tool 10 can comprise a mouthpiece 11 and a mandrel holder 12 that can be moved relative to the mouthpiece 11 in the direction of an operative axis W. For example, the mandrel holder 12 has a chuck housing 13 and at least one, preferably several clamping elements 14, 14′, in particular clamping jaws, which can be moved in the chuck housing 13 along a clamping path. Preferably, the mouthpiece 11 and/or the mandrel holder 12 and/or the chuck housing 13 and/or the clamping elements 14, 14′ are a metal part.

The mouthpiece 11 serves, for example, to receive a rivet (not shown in FIG. 1) to be set, in particular a blind rivet, and preferably has a through hole 11.1, in order to insert the rivet mandrel of the rivet therein. The mandrel holder 12 serves, for example, to fix the rivet mandrel, so that a non-displaceable connection between the received rivet mandrel and the mandrel holder 12 is created. This can take place, for example, via the chuck housing 13 with the clamping elements 14, 14′ arranged movably therein, by means of which the rivet mandrel is fixed in the chuck housing 13, in particular is clamped therein.

For example, a spring element 15 is provided, which acts with a force in the mandrel holder 12, for example via a pressure part 16. The force of the spring element 15 can be used as a pretension force which causes or at least helps the rivet mandrel to be fixed in the mandrel holder 12. For example, the spring element 15 is provided in order to apply a spring force to the clamping elements 14, 14′ to force them into the chuck housing 13. As a result, the clamping elements 14, 14′ are pushed into a clamping position against a rivet mandrel, for example of a blind rivet, introduced via the through hole 11.1 of the mouthpiece 11 into the chuck housing 13. For example, the spring element 15 is a compression spring.

The riveting tool 10 can be actuated by the drive device 30 so that the mandrel holder 12 or the chuck housing 13 with the rivet mandrel fixed therein is moved away from the mouthpiece 11, in the direction of the operative axis W. This happens, for example, by the drive device 30 pulling the mandrel holder 12 or the chuck housing 13 away from the mouthpiece 11. This mode of operation, which is known per se, and the blind riveting which can be carried out with it is described in more detail in the publication EP 0 116 954 A2, to which reference is hereby made for the purpose of completing and supplementing the present disclosure, with the note that the publication may attach a meaning to identically worded terms which differs from the present meaning.

Preferably, the mouthpiece 11 is fixed to the tool housing 4, for example screwed to it. Preferably, the mandrel holder 12, in particular the chuck housing 13 is received in the tool housing 4 so as to be moveable in the direction of the operative axis W. For example, the tool housing 4 is tubular. For example, the mouthpiece 11 is fixed on one end of the tool housing 4 and the opposing end faces towards the device housing 5.

Preferably, the spindle gear 32 is arranged in the device housing 5. Preferably, the spindle gear 32 comprises a threaded spindle 33 having a feed thread 33.3 and a spindle nut 34 that is or can be engaged with the latter. Preferably, the threaded spindle 33 has a front end 33.1, facing towards the mandrel holder 12, in particular the chuck housing 13, and an opposing back end 33.2. Preferably, the threaded spindle 33 and the spindle nut 34 are arranged concentrically to each other with regard to a transmission axis. Preferably, the spindle axis S of the threaded spindle 33 is on the transmission axis. Preferably, the output shaft 31.1 of the electric motor 31 is arranged axially parallel to the transmission axis. Preferably, the transmission axis or the spindle axis S is on the operative axis W.

For example, the threaded spindle 33 and the spindle nut 34 are set up in such a way that the spindle nut 34 is the gear element that is or can be driven by the electric motor 31 and the threaded spindle 33 is used for performing the translational drive movement in order to actuate the riveting tool 10. For example, the threaded spindle 33 is non-displaceably connected to the mandrel holder 12 or the chuck housing 13 at its front end 33.1 directly or indirectly, for example via an intermediate piece. For example, the spindle nut 34 is also rotatably mounted in the radial direction relative to the transmission axis or the operative axis W via at least one, preferably two radial bearings 35, 35′ in the device housing 5.

For example, the radial bearings 35, 35′ are arranged at an axial distance from each other. For example, a drive point is located between the radial bearings 35, 35′, via which the electric motor 31 is operatively connected to the spindle nut 34. For example, the radial bearings 35, 35′ are roller bearings, in particular deep groove ball bearings.

For example, the spindle nut 34 is mounted axially with respect to the transmission axis or the operative axis W via an axial bearing 36 in a support ring 39, serving as a bearing housing, wherein the support ring 39 is supported on the mouthpiece 11 in the axial direction via the tool housing 4. The tool housing 4 itself is held on the support ring 39, in particular held loosely, via a retaining structure 6, such as for example a ring-shaped cover element.

Preferably, the support ring 39 is designed to be resistant to deformation and pressure. For example, the support ring 39 is a metal part. For example, the support ring 39 is a separate component. For example, the axial bearing 36 is an axial roller bearing. In principle, the axial bearing 36 can also be a needle bearing.

As can be seen clearly from FIG. 1, at least one, preferably two reduction stages 37, 37′ can be interposed between the electric motor 31 and the spindle gear 32.

For example, the reduction stages 37, 37′ are connected in series in the force flow. For example, the reduction stages 37, 37′ use a common intermediate shaft 38. For example, at least one of the reduction stages 37, 37′ is a spur gear stage and the associated gear elements are spur gears. Similarly, the device housing 5 can be used for radially mounting the reduction stages 37, 37′. The device housing 5 can also be used for radially mounting the electric motor 31.

In relation to the mounting of the spindle gear 32, in particular the spindle nut 34, to the mounting of the reduction stages 37, 37′, in particular the common intermediate shaft 38, and to the mounting of the electric motor 31, reference is made, for the purpose of the completion and expansion of the present disclosure, to the German patent application with the official file number DE 10 2022 116 406.3, with the note that the patent application may attribute a meaning to identically worded terms which differs from the present meaning.

Preferably, the threaded spindle 33 is formed as a hollow spindle with a through hole 40 extending in the direction of its longitudinal extension. The through hole 40 makes it possible to remove any rivet mandrel remnants remaining from a riveting process from the riveting tool 10. In this case, for example, the pressure part 16 arranged on the front end 33.1 of the threaded spindle 33 is received in the through hole 40 and itself is formed as a hollow body having a through hole 16.1.

For example, the through hole 40 on the back end 33.2 of the threaded spindle 33 leads into a tubular element 50, which in turn leads into a collection container 4. For example, in this manner, a mandrel removal path is realised via the threaded spindle 33, wherein the collection container 4 serves as a collector for mandrel remnants. Preferably, the collection container 4 is arranged fixed integral with the housing relative to the device housing 5, in particular arranged releasably, for example fixed on the device housing 5, in particular releasably fixed thereon.

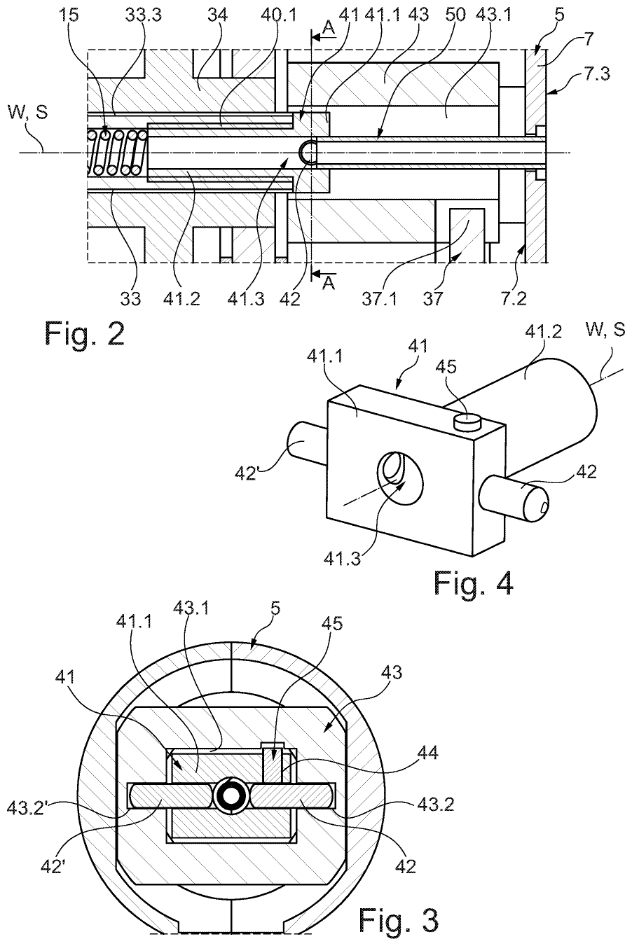

FIG. 2 shows the exemplary riveting device 1 in the region of the spindle gear 32 and of the tubular element 50 in an enlarged section of FIG. 1. FIG. 3 shows the exemplary riveting device 1 in a sectional representation along the section line A-A of

FIG. 2. In particular, as can be seen therefrom, preferably a torque arm 41 is provided, which, for example, is assigned to the threaded spindle 33, in particular in order to secure the threaded spindle 33 against rotation relative to the device housing 5.

In the exemplary riveting device 1, the torque arm 41 is fixed on or connected in a rotationally fixed manner to the threaded spindle 33 via the through hole 40. In this manner, installation space in the radial direction in relation to the spindle axis S is reduced, since a region radially near the centre of the threaded spindle 33 is used for fixing the torque arm 41.

Preferably, the torque arm 41 is fixed on the threaded spindle 33 by screwing it into the through hole 40. For example, the threaded spindle 33, in the region of its back end 33.2, has a fixing thread 40.1, in particular internal thread, in the through hole 40 into which the torque arm 41 is screwed. For example, the pitch of the fixing thread 40.1 is designed to run in the opposite direction to the pitch of the feed thread 33.3 of the threaded spindle 33. Therefore, a self-tightening of the torque arm 41 is enabled with an actuating movement or pulling movement of the threaded spindle 33.

Preferably, the torque arm 41 has a base body 41.1 which protrudes axially from the threaded spindle 33. Preferably, the torque arm 41 has a section inserted into the through hole 40, which is an extension 41.2 of the base body 41.1, for example. For example, the extension 41.2 has a thread, in particular external thread, via which the screw connection is formed with the threaded spindle 33. For example, the extension 41.2 is used as a counter holder for the spring element 15 (FIG. 2).

Preferably, the base body 41.1 prevents rotation of the threaded spindle 33 with respect to a counter bearing 43 via at least one intermediate element 42 or 42′ (FIG. 3). For example, the counter bearing 43 is arranged secured against rotation with respect to the device housing 5. For example, the counter bearing 43 is arranged in the device housing 5. For example, the counter bearing 43 is formed as a hollow body, in particular cage-like hollow body, having a through hole 43.1 extending in the axial direction. For example, the base body 41.1 of the torque arm 41 is received in the through hole 43.1 of the counter bearing 43.

For example, the through hole 43.1 of the counter bearing 43 has an unrounded, in particular polygonal, for example quadrilateral cross-section. For example, the base body 41.1 of the torque arm 41 has an unrounded, in particular polygonal, for example quadrilateral cross-section. Preferably, the cross-section of the through hole 43.1 and the cross-section of the base body 41.1 are formed corresponding to each other. Preferably, the counter bearing 43, in particular the through hole 43.1 of same, and the torque arm 41, in particular the base body 41.1, are arranged coaxially in relation to the spindle axis S or the operative axis W. Preferably, the cross-section of the through hole 43.1 of the counter bearing 43 and the cross-section of the base body 41.1 are formed in such a way that there is a gap between the outer circumference of the base body 41.1 and the circumference of the through hole 43.1.

Preferably, the counter bearing 43 has at least one guide track 43.2 or 43.2′, on which the torque arm 41 is guided while maintaining the anti-rotation protection when the threaded spindle 33 performs a translational movement along the operative axis W. For example, the at least one guide track 43.2 or 43.2′ is formed on a surface section of the through hole 43.1 of the counter bearing 43 and/or on a surface section of a lateral recess in a side wall delimiting the through hole 43.1. For example, the at least one intermediate element 42 or 42′ of the base body 41.1 is guided on the at least one guide track 43.2 or 43.2′. The at least one intermediate element 42 or 42′ of the base body 41.1 can be or comprise a sliding body or a rolling body, such as a needle bearing or a sliding bearing. The intermediate element 42 or 42′ can be a cylindrical pin, for example.

For example, the base body has a bore 44 or another hole in which a magnetically acting magnet element 45 for a sensor device using a magnetic field, such as for example a Hall sensor device, is received. For example, the bore 44 or the hole is arranged with its central axis transverse to the spindle axis S. For example, the magnet element is held in the bore 44 or the hole by magnetic force. For this purpose, the intermediate element 42 or 42′ has or consists of a corresponding metallic material, such as for example iron.

In the exemplary riveting device 1, the at least one reduction stage 37 is arranged in the axial direction between the spindle nut 34 and a wall section 7 of the device housing 5. Preferably, for this case, the reduction stage 37 has a radial extension, originating from the shaft axis A of the intermediate shaft 38, which is smaller than the distance D between he shaft axis A of the intermediate shaft 38 and the facing outer side of the base body 41.1 and/or the threaded spindle 33 (FIG. 1). As a result, in the exemplary riveting device 1, the at least one reduction stage 37, in particular a gear element 37.1 of the at least one reduction stage 37 arranged on the intermediate shaft 38 and/or held in a rotationally fixed manner, is located in the axial direction in the stroke path of the threaded spindle 33, but in the radial direction at a sufficiently large distance that the stroke of the threaded spindle 33 is prevented from being disturbed by the gear element 37.1 during operation of the riveting tool 1 (see, for example, FIG. 2). The gear element 37.1 can be a spur gear.

In order to reduce radial installation space, it is provided, for example, that the base body 41.1 has a radial extension in the direction towards the intermediate shaft 38, which radial extension is at least equal to or smaller than the radial extension of the threaded spindle 33. For example, the intermediate shaft 38 is arranged below the threaded spindle 33 in the vertical direction. For example, the at least one intermediate element 42 or 42′ of the torque arm 41 is arranged in relation to its central axis in the horizontal direction on the base body 41.1. For example, the bore 44 is arranged with the magnet element 45 received therein on the side of the base body 41.1 which is facing away in the vertical direction of the intermediate shaft 38.

FIG. 4 shows the torque arm 41 in a schematic perspective view, represented by way of example with the at least one intermediate element 42 or 42′ and the magnet element 45. The torque arm 41 can be formed as a hollow body having a through hole 41.3 extending in the direction of its longitudinal extension. For example, the through hole 41.3 of the torque arm 41 is a component of the mandrel removal path to the collection container 60.

As can be seen from FIG. 1, the intermediate shaft 38 is radially mounted integral with the housing in relation to the device housing 5 via a radial bearing 46. In order to reduce axial installation space, it can be provided that the radial bearing 46 is present on the side of the reduction stage 37 facing away from the wall section 7, i.e. the reduction stage 37 is arranged between the radial bearing 46 and the wall section 7 of the device housing 5. For example, the reduction stage 37, in particular the one gear element 37.1, is arranged on the intermediate shaft 38 in the region of a free end of the intermediate shaft 38 facing towards the wall section 7. Preferably, in addition to the radial bearing 46, a further radial bearing 46′ is provided, via which the intermediate shaft 38 is radially mounted integral with the housing in relation to the device housing 5.

For example, the tubular element 50 engages with one end into the through hole 40 of the threaded spindle 33. For example, the tubular element 50 remains engaged in the through hole 40 over the stroke length of the threaded spindle 33. Preferably, the tubular element 50 is fixed, for example with its other end, to a wall section arranged integral with the housing in relation to the device housing 5 or is fixed to the wall section 7. For example, the wall section 7 extends transversely, in particular orthogonally, to the tube axis of the tubular element 50. Preferably, the tube axis of the tubular element 50 is coaxial to the operative axis W and/or the spindle axis S.

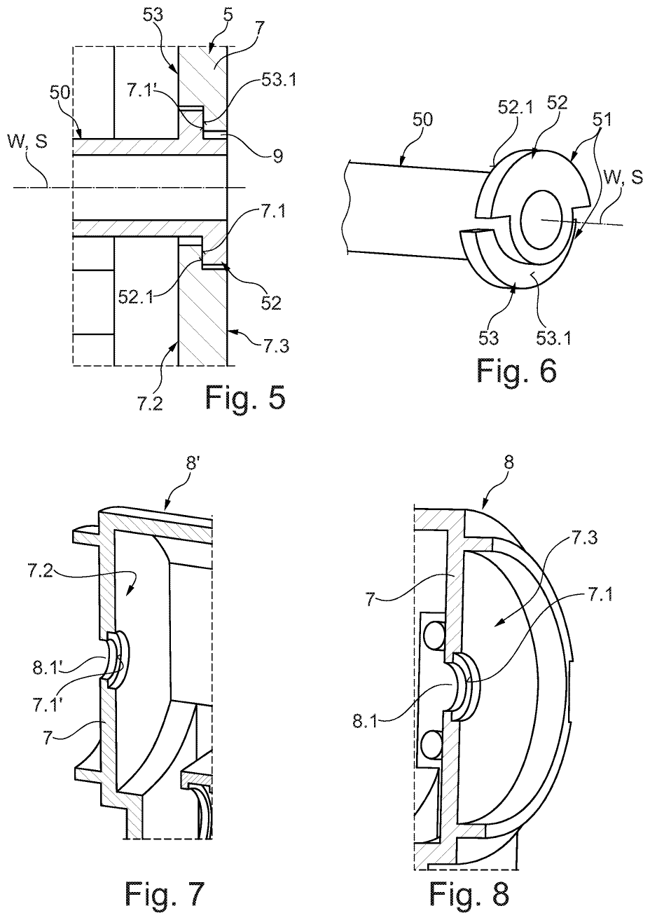

FIG. 5 shows the tubular element 50 in the region of the wall section 7 in an enlarged section of FIG. 2, wherein in FIG. 5, the section plane is rotated 90 degrees compared to the section plane of FIG. 2. FIG. 6 shows the tubular element 50 in a perspective representation.

A fixing structure 51 can be provided for fixing the tubular element 50 on the

device housing 5 or the wall section 7. For example, the fixing structure 51 comprises two flange sections 52, 53 assigned to the tubular element 50, in particular plate-shaped flange sections 52, 53. Preferably, the flange sections 52, 53 are connected fixedly to the tubular element 50, for example moulded thereon. For example, the flange sections 52, 53 are arranged axially offset from each other. For example, the flange sections 52, 53 each extend along a different circumferential section around the outer circumference of the tubular element 50 (FIG. 6).

For example, the flange sections 52, 53 each have a flange surface 52.1 or 53.1, which cooperates with a mating surface 7.1 or 7.1′ of the wall section 7. For example, the flange surfaces 52.1, 53.1 are arranged transversely, in particular orthogonally, to the tube axis of the tubular element 50. For example, the flange sections 52.1, 53.1 point in opposite directions to each other. For example, the associated mating surfaces 6.1, 6.1′ are arranged on different sides of the wall section 7. For example, one of the mating surfaces 6.1, 6.1′ is formed on an inner side 7.2 facing towards the threaded spindle 33 and the other mating surface 6.1′ is formed on an opposite outer side 7.3 of the wall section 7.

In order to reduce axial installation space, the fixing structure 51 can be formed so that it at least essentially ends flush with the inner side 7.2 and/or the outer side 7.3 of the wall section 7 or is lower than the inner side 7.2 and/or the outer side 7.3 of the wall section 7. For this purpose, it is provided, for example, that the flange sections 52, 53 are dimensioned accordingly in their thickness, so that, for example, the outward-facing side of at least one of the flange sections 52, 53, i.e. the side opposite the flange surface 52.1 or 53.1 of the flange section 52 or 53, is essentially flush with the inner side 7.2 and/or the outer side 7.3 of the wall section 7 or is lower than the inner side 7.2 and/or the outer side 7.3 of the wall section 7.

For example, the device housing 5 is constructed from multiple parts, in particular at least two parts, and has at least two housing parts 8, 8′, in particular housing shells. For example, the housing parts 8, 8′ lie next to each other in a parting plane when they are assembled. FIGS. 7 and 8 show by way of example a respective one of the housing parts 8, 8′ in the region of the wall section 7. As can be seen, the housing parts 8, 8′ are each assigned one of the mating surfaces 6.1 or 6.1′ For example, in each case one of the mating surfaces 6.1, 6.1′ is formed on one of the housing parts 8, 8′. The tubular element 50 only needs to be inserted into a receptacle 8.1 or 8.1′ of one of the housing parts 8, 8′ and at the same time the fixing of the tubular element 50 is realised by joining together the housing parts 8, 8′. For example, the receptacles 8.1, 8.1′ form a through hole 9 for the tubular element 50 in the assembled state.

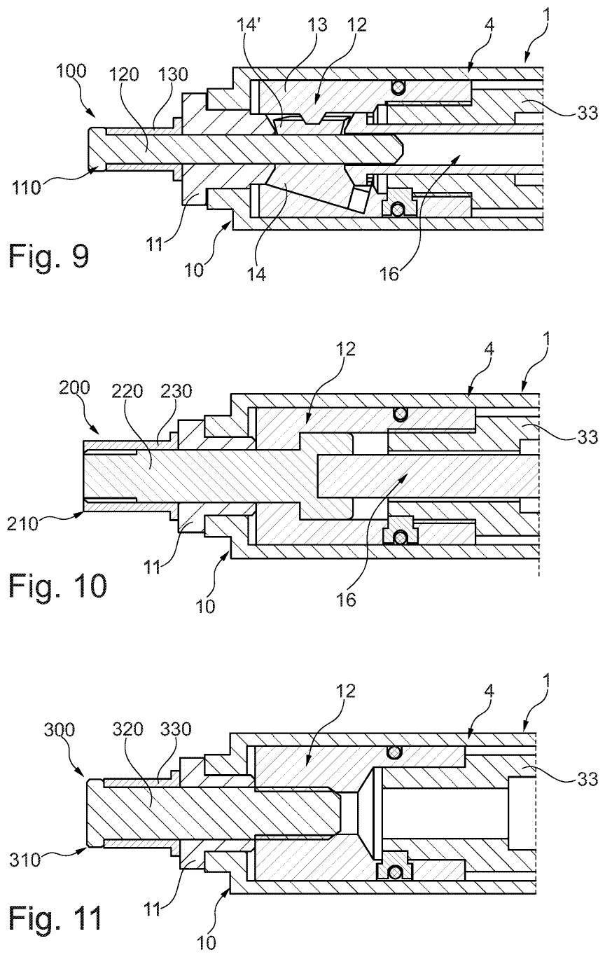

FIG. 9 shows an example of a possible embodiment of a blind rivet setting tool 100. The blind rivet setting tool 100 has the construction of the above-described exemplary riveting device 1, with only a section of the exemplary riveting device 1 being shown in the region of the riveting tool 10 in FIG. 9 for simplicity. In the blind rivet setting tool 100, a rivet mandrel 120 of a blind rivet 110 is introduced into the mouthpiece 11 and received in the mandrel holder 12, in particular the chuck housing 13, and fixed in the axial direction, for example by the at least one clamping element 14 or 14′. FIG. 9 shows the blind rivet 110 in the state before riveting, in which the rivet body 130 of the blind rivet 110 is still in its initial state.

FIG. 10 shows an example of a possible embodiment of a blind rivet nut setting tool 200. The blind rivet nut setting tool 200 has the construction of the above-described exemplary riveting device 1, wherein the mandrel holder 12 and the pressure part 16 are modified with regard to a rivet mandrel for a blind rivet nut and the rivet mandrel is a threaded rivet mandrel. For example, the pressure part 16 has a function there with regard to threading the threaded rivet mandrel into the blind rivet nut. In FIG. 10, only a section of the riveting device 1 is shown in the region of the riveting tool 10 for simplicity. With the blind rivet nut setting tool 200, a threaded rivet mandrel 220 for a blind rivet nut 210 is received in the mandrel holder 12. FIG. 10 shows the blind rivet nut 210 in the state before riveting, in which the rivet body 230 of the blind rivet nut 210 is still in its initial state.

For example, with the exemplary blind rivet nut setting device 200, the pressure part 16 is introduced into a receptacle of the threaded rivet mandrel 220 and forms a positive-locking rotationally-fixed connection to the threaded rivet mandrel 220 via the receptacle. For example, the pressure part 16 is held in the receptacle of the threaded rivet mandrel 220 by the force of the spring element 15 of the riveting device 1 (FIG. 1), which acts axially on the pressure part 16.

FIG. 11 shows an example of a possible embodiment of a blind rivet screw setting tool 300. The blind rivet screw setting tool 300 has the construction of the above-described riveting device 1, wherein the mandrel holder 12 is modified with regard to a rivet mandrel of a blind rivet screw and the rivet mandrel is a threaded rivet mandrel. In FIG. 11, only a section of the riveting device 1 is shown in the region of the riveting tool 10 for simplicity. With the blind rivet screw setting tool 300, a threaded rivet mandrel 320 of a blind rivet screw 310 is received in the mandrel holder 12. FIG. 11 shows the blind rivet screw 310 in the state before riveting, in which the rivet body 330 of the blind rivet screw 310 is still in its initial state.

### REFERENCE NUMERAL LIST

1 riveting device
2 handle part
2.1 gripping surface
3 accumulator
4 tool housing
5 device housing
6 retaining structure
7 wall section
7.1, 7.1′ mating surface
7.2 inner side
7.3 outer side
8, 8′ housing part
8.1, 8.1′ receptacle
9 through hole
10 riveting tool
11 mouthpiece
11.1 through hole
12 mandrel holder
13 chuck housing
14, 14′ clamping element
15 spring element
16 pressure part
16.1 through hole
30 drive device
31 electric motor
31.1 output shaft
32 spindle gear
33 threaded spindle
33.1 front end
33.2 back end
33.3 feed thread
34 spindle nut
35, 35′ radial bearing
36 axial bearing
37, 37′ reduction stage
37.1 gear element
38 intermediate shaft
39 support ring
40 through hole
40.1 fixing thread
41 torque arm
41.1 base body
41.2 extension
41.3 through hole
42, 42′ intermediate element
43 counter bearing
43.1 through hole
43.2, 43.2′ guide track
44 bore
45 magnet element
46, 46′ radial bearing
50 tubular element
51 fixing structure
52 flange section
52.1 flange surface
53 flange section
53.1 flange surface
60 collection container
100 blind rivet setting tool
110 blind rivet
120 rivet mandrel
130 rivet body
200 blind rivet nut setting tool
210 blind rivet nut
220 threaded rivet mandrel
230 rivet body
300 blind rivet screw setting tool
310 blind rivet screw
320 threaded rivet mandrel
330 rivet body
W operative axis
S spindle axis
A shaft axis
D distance

1.-22. (canceled)

23. A riveting device (1), comprising:
a device housing (5);
a riveting tool (10) having
a mouthpiece (11) and
a mandrel holder (12),
wherein the mandrel holder (12) can be moved relative to the mouthpiece (11) along an operative axis (w); and
a drive device (30) in the device housing (5) for actuating the riveting tool (10) with a threaded spindle (33),
wherein the threaded spindle (33) has a feed thread (33.3),
wherein the threaded spindle (33) is operatively connected to the mandrel holder (12) and is configured to be moved along the operative axis (W),
wherein the threaded spindle (33) is formed as a hollow spindle having a through hole (40) extending in a direction of its longitudinal extension,
wherein the threaded spindle (33) is coupled to a torque arm (41),
wherein the torque arm (41) secures the threaded spindle (33) against rotation relative to the device housing (5), and
wherein the torque arm (41) is fixed on the threaded spindle (33) via the through hole (40).

24. The riveting device according to claim 23,
wherein the torque arm (41) is fixed on the threaded spindle (33) by screwing it into the through hole (40).

25. The riveting device according to claim 24,
wherein the threaded spindle (33) has a fixing thread (40.1) running in the opposite direction to its feed thread (33.3) in the through hole (40), and
wherein the torque arm (41) is screwed into the through hole (40) while engaging into the fixing thread (40.1).

26. The riveting device according to claim 24,
wherein the riveting device (1) is a hand riveting device and includes a handle part (2), and
wherein the handle part (2) is formed on the device housing (5).

27. A blind rivet setting tool (100), comprising:
the riveting device (1) according to claim 23, and
a rivet mandrel (120) of a blind rivet (110) to be set, a blind rivet nut (210) to be set, or a blind rivet screw (310) to be set,
wherein the rivet mandrel is received in the mandrel holder (12) of the riveting device (1).

28. A riveting device (1), comprising:
a device housing (5);
a riveting tool (10) having
a mouthpiece (11) and
a mandrel holder (12),
wherein the mandrel holder (12) can be moved relative to the mouthpiece (11) along an operative axis (w); and
a drive device (30) in the device housing (5) for actuating the riveting tool (10) with a threaded spindle (33),
wherein the threaded spindle (33) has a feed thread (33.3),
wherein the threaded spindle (33) is operatively connected to the mandrel holder (12) and is configured to be moved along the operative axis (W),
wherein the threaded spindle (33) is formed as a hollow spindle having a through hole (40) extending in a direction of its longitudinal extension,
wherein the threaded spindle (33) is coupled to a torque arm (41),
wherein the torque arm (41) secures the threaded spindle (33) against rotation relative to the device housing (5),
wherein the torque arm (41) is fixed to the threaded spindle (33) by screwing it on via a fixing thread (40.1), and
wherein the fixing thread (40.1) runs in the opposite direction to the feed thread (33.3) of the threaded spindle (33).

29. The riveting device according to claim 28,
wherein the torque arm (41) has a base body (41.1) which protrudes axially from the threaded spindle (33) and prevents rotation with respect to a counter bearing (43) secured against rotation with respect to the device housing (5) directly or indirectly via at least one intermediate element (42).

30. The riveting device according to claim 29,
wherein the base body (41.1) has a bore (44) extending transversely to a spindle axis(S) of the threaded spindle (32.1), and
wherein a magnet element (45) for a Hall sensor device is received in the bore (44).

31. The riveting device according to claim 30,
wherein the intermediate element (42) is an iron element, and the bore (44) is arranged near the intermediate element (42), so that the magnet element (45) is held in the bore (44) by a magnetic force.

32. The riveting device according to claim 29,
wherein the base body (41.1) has a radial extension originating from a spindle axis(S) in at least one spatial direction, and
wherein the radial extension is smaller than or equal to the radial extension of the threaded spindle (33) in a region of the base body (41.1).

33. The riveting device according to claim 29,
wherein the threaded spindle (33) is engaged with a spindle nut (34) of a spindle gear (32), and
wherein the drive device (30) has an electric motor (31) and a reduction stage (37), interposed between the electric motor (31) and the spindle gear (32), having an intermediate shaft (38),
wherein the reduction stage (37) is arranged between the spindle nut (34) and a wall section (7) of the device housing (5) in an axial direction.

34. The riveting device according to claim 33,
wherein the reduction stage (37) has a radial extension originating from a shaft axis (A) of the intermediate shaft (38),
wherein the radial extension is smaller than a distance between the shaft axis (A) of the intermediate shaft (38) and a facing outer side of the base body (41.1) and/or the threaded spindle (33).

35. The riveting device according to claim 33,
wherein the intermediate shaft (38) is mounted radially integral with the housing in relation to the device housing (5) via a radial bearing (46), and
wherein the radial bearing (46) is on a side of the reduction stage (37) facing away from the wall section (7).

36. The riveting device according to claim 35,
wherein a gear element (37.1) of the reduction stage (37) is arranged on the intermediate shaft (38) in a region of a free end of the intermediate shaft (38) facing towards the wall section (7).

37. The riveting device according to claim 35,
wherein the riveting device (1) comprises a spring element (15),
wherein the spring element (15) acts with a force inside the mandrel holder (12),
wherein the spring element (15) is arranged in the through hole (40) of the threaded spindle (33), and
wherein an extension (41.2) of a torque arm (41) present in the through hole (40) serves as a counter holder for the spring element (15).

38. The riveting device according to claim 28,
wherein the riveting device (1) is a hand riveting device and includes a handle part (2), and
wherein the handle part (2) is formed on the device housing (5).

39. A blind rivet setting tool (100), comprising:
the riveting device (1) according to claim 28, and
a rivet mandrel (120) of a blind rivet (110) to be set, a blind rivet nut (210) to be set, or a blind rivet screw (310) to be set,
wherein the rivet mandrel is received in the mandrel holder (12) of the riveting device (1).
